(19) United States
(12) Patent Application Publication
(10) Pub. No.: US 2024/0283255 A1
(43) Pub. Date: Aug. 22, 2024

(54) SYSTEM, METHOD, AND APPARATUS WITH BATTERY MANAGEMENT

(71) Applicant: SAMSUNG ELECTRONICS CO., LTD., Suwon-si (KR)

(72) Inventors: Oleg PETRAKIVSKYI, Zhytomyr (UA); Ivan DOROSHENKO, Chernihiv (UA); Oleksandr BAIEV, Zaporizhzhia (UA)

(73) Assignee: SAMSUNG ELECTRONICS CO., LTD., Suwon-si (KR)

(21) Appl. No.: 18/466,339

(22) Filed: Sep. 13, 2023

(30) Foreign Application Priority Data
Feb. 16, 2023 (KR) 10-2023-0020512

(51) Int. Cl. H02J 7/00

(52) U.S. Cl. CPC H02J 7/00032; H02J 7/0013

(57) ABSTRACT

A battery apparatus including a plurality of slave battery management systems (BMSs) configured to manage battery cells of battery modules, respectively and a master BMS configured to manage the plurality of slave BMSs, and in response to the master BMS broadcasting a first address setting command to the plurality of slave BMSs using a first interface, the plurality of slave BMSs is configured to enter a target identification mode for identifying an address setting target among the plurality of slave BMSs, and in response to the master BMS transmitting an identification signal to the plurality of slave BMSs using a second interface that is distinguished from the first interface, a first slave BMS is identified among the plurality of slave BMSs, where the first slave BMS is configured to perform an address setting process according to the first address setting command.

### CROSS-REFERENCE TO RELATED APPLICATIONS

This application claims the benefit under 35 USC § 119(a) of Korean Patent Application No. 10-2023-0020512, filed on Feb. 16, 2023, in the Korean Intellectual Property Office, the entire disclosure of which is incorporated herein by reference for all purposes.

### BACKGROUND

### 1. Field

The following description relates to a system, method, and apparatus with battery management.

### 2. Description of Related Art

A battery pack may include a plurality of battery cells. The battery pack may supply power to an apparatus that uses power (e.g., an electric vehicle). A battery management system (BMS) may monitor the plurality of battery cells of the battery pack and may efficiently operate the plurality of battery cells.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provide an electronic apparatus including a plurality of slave battery management systems (BMSs) configured to manage battery cells of battery modules, respectively and a master BMS configured to manage the plurality of slave BMSs, and in response to the master BMS broadcasting a first address setting command to the plurality of slave BMSs using a first interface, the plurality of slave BMSs is configured to enter a target identification mode for identifying an address setting target among the plurality of slave BMSs, and in response to the master BMS transmitting an identification signal to the plurality of slave BMSs using a second interface that is distinguished from the first interface, a first slave BMS is identified among the plurality of slave BMSs, where the first slave BMS is configured to perform an address setting process according to the first address setting command.

The master BMS may include an identification signal generator, the plurality of slave BMSs may include identification signal detectors, respectively, and, as the plurality of slave BMSs enters the target identification mode, identification paths connecting the identification signal generator to the respective identification signal detectors of the plurality of slave BMSs are activated.

The master BMS and the plurality of slave BMSs may include identification mode switches, respectively, and the identification paths may be activated as respective identification mode switches of the master BMS and the plurality of slave BMSs are in a closed state in the target identification mode.

The respective identification mode switches of the master BMS and the plurality of slave BMSs may be in the closed state and then back in an open state in response to a reference time elapsing.

The first slave BMS may be configured to perform the address setting process according to the first address setting command and then to cause a bypass switch of the first slave BMS to be in a closed state, and, as the bypass switch of the first slave BMS is in the closed state, a partial path of the first slave BMS among the identification paths is deactivated.

In response to the master BMS broadcasting a second address setting command to the plurality of slave BMSs using the first interface, the plurality of slave BMSs may be configured to enter the target identification mode, and, in response to the master BMS transmitting the identification signal to the plurality of slave BMSs using the second interface, a second slave BMS is identified among the plurality of slave BMSs due to the deactivation of the partial path of the first slave BMS, and the second slave BMS may be configured to perform the address setting process according to the second address setting command.

The first slave BMS may be configured to notify the master BMS of address setting completion, after completing the address setting process according to the first address setting command.

The first interface may be configured to connect the master BMS to the plurality of slave BMSs in parallel, and the second interface may be configured to connect the master BMS to the plurality of slave BMSs in series.

The first interface may correspond to a data bus.

The second interface may correspond to a power line providing power from the respective battery modules of the plurality of slave BMSs.

The second interface may be used for power line communication and the identification signal may use a high frequency that is distinguished from a frequency of the power from the respective battery modules of the plurality of slave BMSs.

A number of slave BMSs is N, the plurality of slave BMSs may be configured to notify the master BMS of address setting completion, after each completing of the address setting process, the master BMS may be configured to broadcast an N+1 address setting command, and the master BMS may be configured to terminate the broadcasting of the N+1 address command in response to an address setting completion for the N+1 address setting command not being confirmed.

In a general aspect here is provide a processor-implemented, the method including broadcasting a first address setting command to a plurality of slave BMSs using a first interface, and transmitting an identification signal to the plurality of slave BMSs using a second interface that is distinguished from the first interface, in response to the plurality of slave BMSs entering a target identification mode for identifying an address setting target among the plurality of slave BMSs, and, in response to a first slave BMS being identified among the plurality of slave BMSs by the identification signal in the target identification mode, an address setting process according to the first address setting command is performed by the first slave BMS.

As the plurality of slave BMSs enters the target identification mode, identification paths connecting the identification signal generator to the respective identification signal detectors of the plurality of slave BMSs may be activated.

The master BMS and the plurality of slave BMSs may each include identification mode switches, respectively, and the identification paths may be activated as respective identification mode switches of the master BMS and the plurality of slave BMSs are in a closed state in the target identification mode.

The first slave BMS may be configured to perform the address setting process according to the first address setting command and then to cause a bypass switch of the first slave BMS to be in a closed state, and, as the bypass switch of the first slave BMS is in the closed state, a partial path of the first slave BMS among the identification paths may be deactivated.

The first interface may be configured to connect the master BMS to the plurality of slave BMSs in parallel, and the second interface may be configured to connect the master BMS to the plurality of slave BMSs in series.

The second interface may correspond to a power line providing power from the respective battery modules of the plurality of slave BMSs, and the identification signal may use a high frequency that is distinguished from a frequency of the power from the respective battery modules of the plurality of slave BMSs.

In a general aspect, here is provided an electric vehicle including a battery pack comprising a plurality of slave battery management systems (BMSs) configured to manage battery cells of battery modules, respectively, and a master BMS configured to manage the plurality of slave BMSs and an electric motor configured to provide power using the battery pack, where, in response to the master BMS broadcasting a first address setting command to the plurality of slave BMSs using a first interface, the plurality of slave BMSs is configured to enter a target identification mode for identifying an address setting target among the plurality of slave BMSs, in response to the master BMS transmitting an identification signal to the plurality of slave BMSs using a second interface that is distinguished from the first interface, a first slave BMS is identified among the plurality of slave BMSs, and the first slave BMS may be configured to perform an address setting process according to the first address setting command.

In a general aspect, here is provided a battery system including a plurality of battery modules, a plurality of slave battery management systems (SBMSs) configured to control a respective one of the plurality of battery modules, and a master battery management system (MBMS), the MBMS configured to broadcast a first address setting command to the plurality of SBMSs using a first interface to instruct the plurality of SBMSs to identify an address setting target among the plurality of SBMSs and iteratively transmit respective identification signals to respective ones of the plurality of SBMSs using a second interface to instruct the respective SBMSs to perform a respective address setting process.

Each respective SBMS may be configured to notify the MBMS of address setting completion, after completing the address setting process according to the first address setting command.

The first interface may be configured to connect the MBMS to the plurality of SBMSs in parallel, and the second interface may be configured to connect the MBMS to the plurality of SBMSs in series.

Each respective SBMS may be configured to cause a respective bypass switch to be in a closed state responsive to completing the respective address setting process, and, as the respective bypass switch enters the closed state, respective partial paths among the SBMS are deactivated.

Other features and aspects will be apparent from the following detailed description, the drawings, and the claims.

### BRIEF DESCRIPTION OF THE DRAWINGS

FIG. 1 illustrates an example electric vehicle system including a battery pack and battery modules according to one or more embodiments.

FIG. 2 illustrates an example BMSs electronic system according to one or more embodiments.

FIGS. 3A to 3F illustrate an example circuit structure of an electronic system including a master BMS and slave BMSs according to one or more embodiments.

FIG. 4 illustrates an example method according to one or more embodiments.

FIG. 5 illustrates an example method according to one or more embodiments.

FIG. 6 illustrates an example method according to one or more embodiments.

FIG. 7 illustrates an example method of transmitting an identification signal according to one or more embodiments.

FIG. 8 illustrates an example battery management method of a master BMS according to one or more embodiments.

Throughout the drawings and the detailed description, unless otherwise described or provided, the same, or like, drawing reference numerals may be understood to refer to the, or like, elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when a component or element is described as being “on”, “connected to,” “coupled to,” or “joined to” another component, element, or layer it may be directly (e.g., in contact with the other component or element) “on”, “connected to,” “coupled to,” or “joined to” the other component, element, or layer or there may reasonably be one or more other components, elements, layers intervening therebetween. When a component or element is described as being “directly on”, “directly connected to,” “directly coupled to,” or “directly joined” to another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and Is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Due to manufacturing techniques and/or tolerances, variations of the shapes shown in the drawings may occur. Thus, the examples described herein are not limited to the specific shapes shown in the drawings, but include changes in shape that occur during manufacturing.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

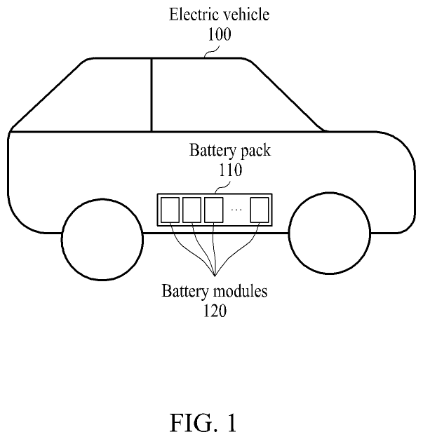

FIG. 1 illustrates an example electric vehicle system including a battery pack and battery modules according to one or more embodiments. Referring to FIG. 1, in a non-limiting example, an electric vehicle 100 includes a battery pack 110. The electric vehicle 100 may run on electricity. The electric vehicle 100 may include an electric motor. The electric motor may provide power to the electric vehicle 100 using power provided by the battery pack 110. The battery pack 110 may have a rechargeable characteristic and may supply power required for driving the electric vehicle 100. The battery pack 110 may include battery modules 120. The battery modules 120 may each include rechargeable battery cells. The battery cells of the battery modules 120 may be connected in series. In addition, the battery modules 120 may also be connected in series.

In a non-limiting example, the battery pack 110 may be managed through a battery management system (BMS). The BMS may include a master BMS and slave BMSs. The BMS may operate the battery pack 110 in a safe and efficient manner. For example, the BMS may monitor the voltage, current, temperature, and state of charge (SoC) of a battery and may prevent overheating, overcharging, and overdischarging of the battery. The battery modules 120 may be managed by the slave BMSs, respectively, and the slave BMSs of the battery modules 120 may be managed by the master BMS. The master BMS may define respective physical locations of the slave BMSs and may perform a battery management algorithm using the respective physical locations of the slave BMSs. The slave BMSs may have unique addresses respectively corresponding to their respective physical locations. The slave BMSs may be identified using their respective addresses.

In an example, an address may be assigned to each slave BMS through an automatic address assignment procedure. When the master BMS broadcasts an n-th address setting command to the slave BMSs using a first interface, the slave BMSs may enter a target identification mode for identifying an address setting target among the slave BMSs. The number of slave BMSs may be N, where n may be a natural number from 1 to N. When the master BMS transmits an identification signal to the slave BMSs using a second interface that is distinguished from the first interface, an n-th slave BMS may be identified among the slave BMSs. The n-th slave BMS may perform an address setting process according to the n-th address setting command. When this address setting process is repeated N times and the address setting processes for the first slave BMS to the N-th slave BMS is completed, and the master BMS may perform the battery management algorithm using the respective addresses of the slave BMSs.

Although the electric vehicle 100 is illustrated as a battery apparatus supplied with power from the battery pack 110 in FIG. 1, examples may be applied to various, other battery apparatuses such as an energy storage system and a solar panel.

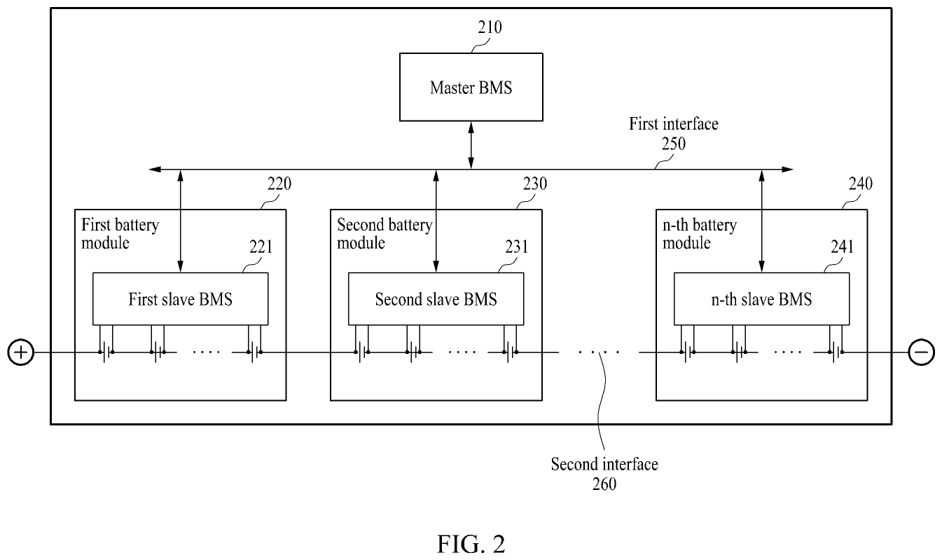

FIG. 2 illustrates an example electronic system including a master BMS, slave BMSs, and interfaces according to one or more embodiments. Referring to FIG. 2, in a non-limiting example, a master BMS 210 and slave BMSs 221, 231, and 241 may be connected to one another through interfaces 250 and 260. The first interface 250 may correspond to a communication bus and the second interface 260 may correspond to a power bus.

Battery modules 220, 230, and 240 may include battery cells, respectively. The second interface 260 may connect the battery cells of the battery modules 220, 230, and 240 in series. The slave BMSs 221, 231, and 241 may respectively manage the battery modules 220, 230, and 240. The slave BMSs 221, 231, and 241 may sense the voltage and temperature of the battery cells and may perform cell balancing. In a master-slave architecture, the slave BMSs 221, 231, and 241 may separately and respectively control the battery cells of the battery modules 220, 230, and 240. The master BMS 210 may perform battery current sensing, slave control, and battery management algorithms (e.g., SoC, state of health (SoH)).

The first interface 250 may provide data exchange between the master BMS 210 and the slave BMSs 221, 231, and 241. The first interface 250 may correspond to a wireless or a wired. The first interface 250 may use a data bus topology. In this case, the slave BMSs 221, 231, and 241 may be simultaneously connected to a data bus of the first interface 250 and directly communicate with the master BMS 210. In this case, unique addresses may be assigned to the slave BMSs 221, 231, and 241, and unambiguous communication may be achieved through the respective unique addresses.

The second interface 260 may correspond to a power line providing power from the battery modules 220, 230, and 240 of the slave BMSs 221, 231, and 241. The battery cells of the battery modules 220, 230, and 240 may be connected in series through the second interface 260. In an example, the second interface 260 may be used for powerline communication (PLC). In an example, the parallel characteristic of the first interface 250 and the serial characteristic of the second interface 260 may be used in an address assignment algorithm.

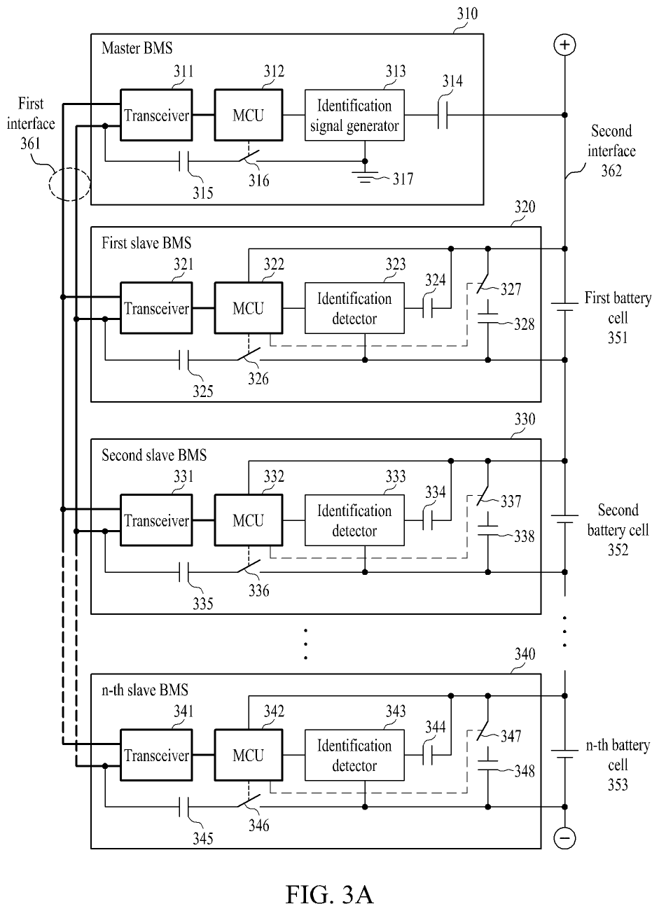

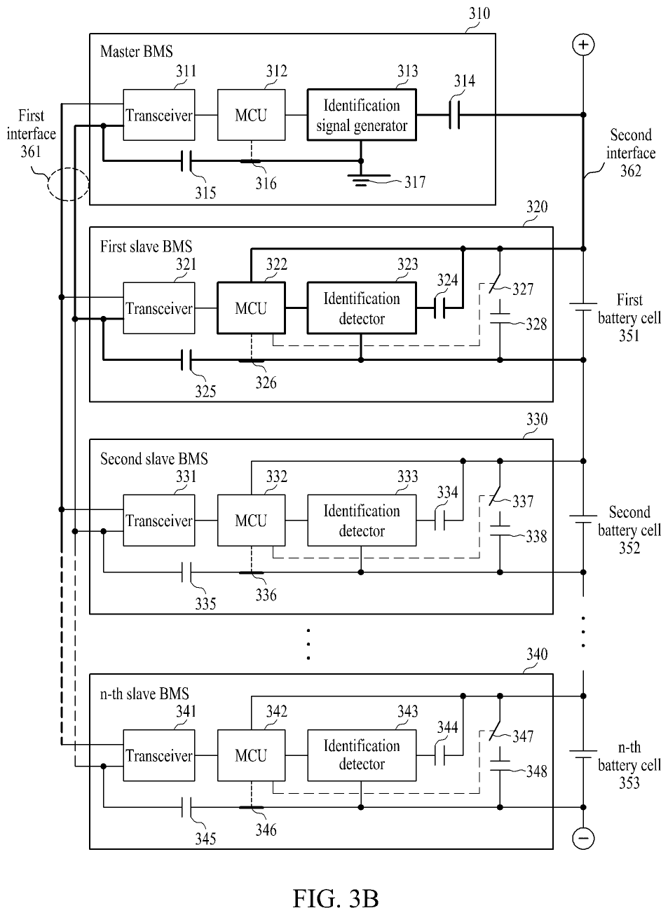

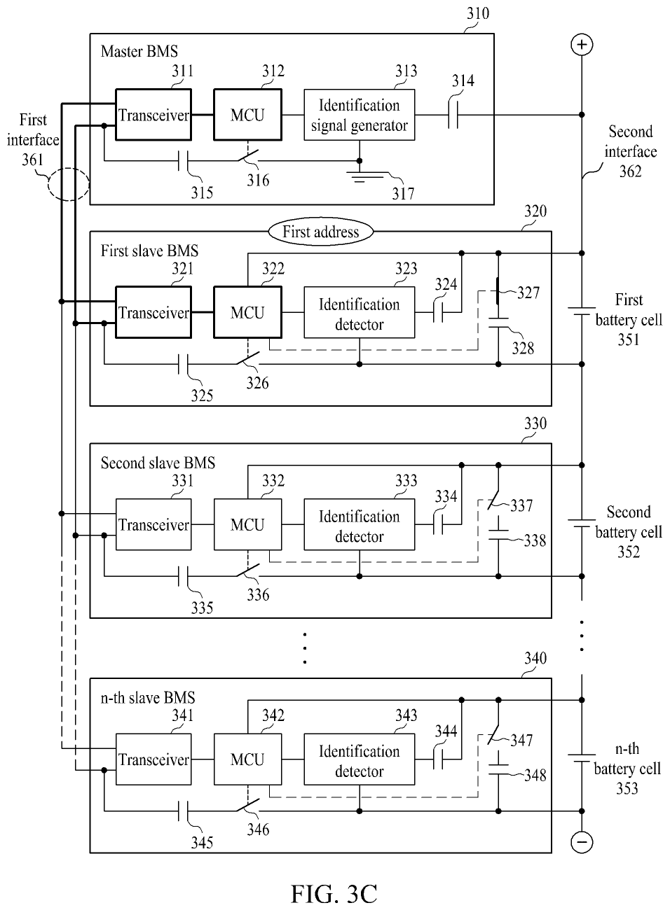

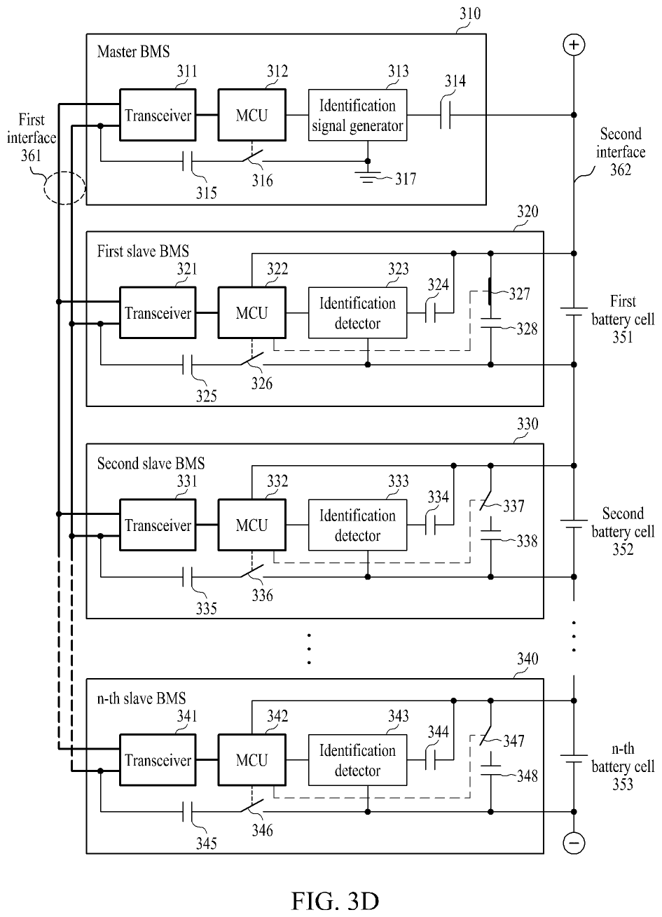

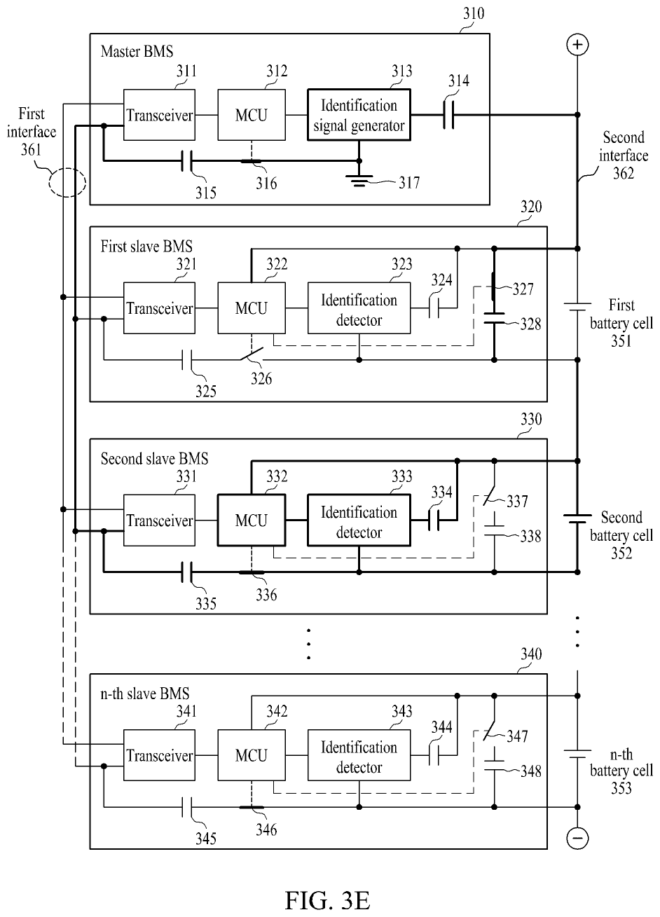

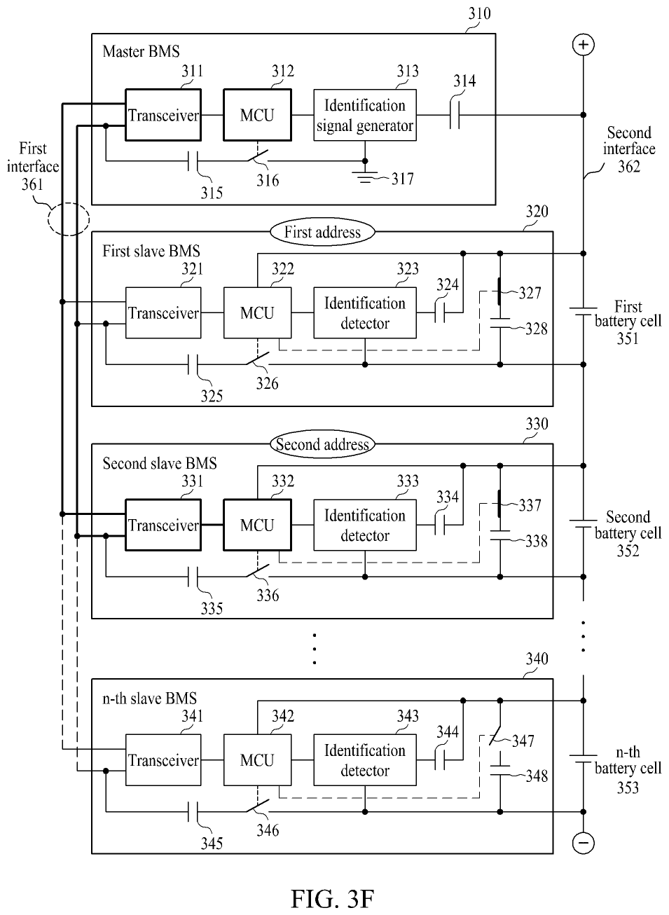

FIGS. 3A to 3F illustrate an example electronic system including a master BMS and slave BMSs according to one or more embodiments. Referring to FIGS. 3A to 3F, in a non-limiting example, a master BMS 310 may include a transceiver 311, a microcontroller unit (MCU) 312, an identification signal generator 313, an identification mode capacitor 314, an identification mode ground capacitor 315, an identification mode switch 316, and master ground 317. A first slave BMS 320 may include a transceiver 321, an MCU 322, an identification signal detector 323, an identification mode capacitor 324, an identification mode ground capacitor 325, an identification mode switch 326, a bypass switch 327, and a bypass capacitor 328. A second slave BMS 330 may include a transceiver 331, an MCU 332, an identification signal detector 333, an identification mode capacitor 334, an identification mode ground capacitor 335, an identification mode switch 336, a bypass switch 337, and a bypass capacitor 338. additional slave BMS, up to n-th slave BMS 340, may each respectively include a transceiver (e.g., transceiver 341), an MCU (e.g., MCU 342), an identification signal detector (e.g., identification signal detector 343), an identification mode capacitor (e.g., identification mode capacitor 344), an (e.g., identification mode ground capacitor 345), an identification mode switch (e.g., identification mode switch 346), a bypass switch (e.g., bypass switch 347), and a bypass capacitor (e.g., bypass capacitor 348).

The master BMS 310 and the slave BMSs 320, 330, and 340 may communicate with one another using the transceivers 311, 321, 331, and 341 and a first interface 361. Referring to FIG. 3A, in a non-limiting example, the master BMS 310 may broadcast a first address setting command to the slave BMSs 320, 330, and 340 using the first interface 361. The first address setting command may be generated by the MCU 312 and may be transferred to the MCUs 322, 332, and 342 through the transceivers 311, 321, 331, and 341 and the first interface 361. The first address setting command may be transmitted in parallel through the first interface 361. The MCUs 322, 332, and 342 may receive a first address value according to the first address setting command through the transceivers 311, 321, 331, and 341 and the first interface 361 and may store the first address value in memories of the MCUs 322, 332, and 342. According to an example, the first address value may be included in the first address setting command.

Referring to FIG. 3B, in a non-limiting example, and according to the first address setting command, the slave BMSs 320, 330, and 340 may enter the target identification mode to identify an address setting target among the slave BMSs 320, 330, and 340. As the slave BMSs 320, 330, and 340 enter the target identification mode, identification paths connecting the identification signal generator 313 to the identification signal detectors 323, 333, and 343 of the slave BMSs 320, 330, and 340 may be activated. In the target identification mode, the identification mode switch 316 of the master BMS 310 and the identification mode switches 326, 336, and 346 of the slave BMSs 320, 330, and 340 may be in a closed state to activate the identification paths. The identification mode switches 316, 326, 336, and 346 may remain in the closed state for a reference time. The identification mode switches 316, 326, 336, and 346 may be in the closed state and then back in an open state when the reference time elapses.

In the target identification mode, the master BMS 310 may transmit an identification signal to the slave BMSs 320, 330, and 340 using a second interface 362. The identification signal may be transmitted in series through the second interface 362. The first slave BMS 320 may be identified among the slave BMSs 320, 330, and 340 through the identification signal. Since the second interface 362 connects the master BMS 310 and the slave BMSs 320, 330, and 340, or more specifically, the identification signal generator 313 and the identification signal detectors 323, 333, and 343 in series, the identification signal generated by the identification signal generator 313 may be detected by the identification signal detector 323 of the first slave BMS 320 closest to the master BMS 310. In an example, the identification signal may correspond to a high frequency signal. The second interface 362 may correspond to a power line providing power from battery cells 351, 352, and 353. The identification signal may use a high frequency that is distinguished from the frequency of the power provided by the battery cells 351, 352, and 353 of the slave BMSs 320, 330, and 340.

The identification mode switches 316, 326, 336, and 346 may remain in the closed state for the reference time. Referring to FIG. 3C, in a non-limiting example, after the reference time elapses, the identification mode switches 316, 326, 336, and 346 may be back in the open state. As the identification mode switches 316, 326, 336, and 346 are open, the identification paths may be deactivated and the target identification mode may be terminated. The first slave BMS 320 may perform an address setting process according to the first address setting command. The first slave BMS 320 may perform the address setting process using the first address value stored in the memory of the MCU 322. According to the address setting process, the first address value may be set as a unique address of the first slave BMS 320. The first slave BMS 320 may notify the master BMS 310 of completing the address setting process, after completing the address setting process according to the first address setting command.

In an example, the first slave BMS 320 may perform the address setting process according to the first address setting command and then cause the bypass switch 327 of the first slave BMS 320 to be in a closed state. As the bypass switch 327 of the first slave BMS 320 is in the closed state, a partial path of the first slave BMS 320 among the identification paths may be deactivated. The partial path of the first slave BMS 320 may refer to a part of a path belonging to the first slave BMS 320 among the identification paths through which an identification signal may be transferred from the master BMS 310 to the slave BMSs 320, 330, and 340. As described in further detail below, as the partial path of the first slave BMS 320 is deactivated among the identification paths, the next identification signal may be detected by the second slave BMS 330 rather than the first slave BMS 320.

Referring to FIG. 3D, in a non-limiting example, the master BMS 310 may broadcast a second address setting command to the slave BMSs 320, 330, and 340 using the first interface 361. According to an example, the master BMS 310 may broadcast the second address setting command after receiving an address setting completion notification from the first slave BMS 320. The second address setting command may be generated by the MCU 312 and transferred to the MCUs 322, 332, and 342 through the transceivers 311, 321, 331, and 341 and the first interface 361. The MCUs 322, 332, and 342 may receive a second address value according to the second address setting command through the transceivers 311, 321, 331, and 341 and the first interface 361. Among the MCUs 322, 332, and 342, the MCUs 332 and 342, to which addresses have not yet been assigned, may store the second address value in the memories of the MCUs 332 and 342. In an example, the second address value may be included in the second address setting command.

Referring to FIG. 3E, in a non-limiting example, the slave BMSs 320, 330, and 340 may enter the target identification mode according to the second address setting command. As the slave BMSs 320, 330, and 340 enter the target identification mode, the identification paths connecting the identification signal generator 313 to the identification signal detectors 333 and 343 of the slave BMSs 330 and 340 may be activated. In the target identification mode, the identification mode switch 316 of the master BMS 310 and the identification mode switches 336 and 346 of the slave BMSs 330 and 340 may be in a closed state to activate the identification paths. Despite entering the target identification mode, the identification mode switch 326 of the first slave BMS 320 may be in an open state and the bypass switch 327 may be in a closed state instead of the identification mode switch 326. In forming the identification paths, as the identification mode switch 326 is open and the bypass switch 327 is closed, the partial path of the first slave BMS 320 among the identification paths may be deactivated.

In the target identification mode, the master BMS 310 may transmit the identification signal to the slave BMSs 320, 330, and 340 using the second interface 362. The identification signal may be transmitted through the second interface 362 in series. Due to the deactivation of the partial path of the first slave BMS 320, the second slave BMS 330 may be identified among the slave BMSs 320, 330, and 340. Due to the open state of the identification mode switch 326 and the closed state of the bypass switch 327, the identification signal generated by the identification signal generator 313 may be detected by the identification signal detector 333 of the second slave BMS 330 second closest to the master BMS 310, after the first slave BMS 320.

Referring to FIG. 3F, in a non-limiting example, after the reference time elapses, the identification mode switches 316, 326, 336, and 346 may be back in the open state. The second slave BMS 330 may perform the address setting process according to the second address setting command. The second slave BMS 330 may perform the address setting using the second address value stored in the memory of the MCU 332. According to the address setting process, the second address value may be set as a unique address of the second slave BMS 330. The second slave BMS 330 may notify the master BMS 310 of address setting completion, after completing the address setting process according to the second address setting command.

In an example, the number of slaves (e.g., BMSs 320, 330, and 340) may be N. The address setting of the first slave BMS 320 to the N-th slave BMS 340 may be performed through the first address setting command to an N-th address setting command. The slave BMSs 320, 330, and 340 may notify the master BMS 310 of address setting completion, after completing each address setting process. The master BMS 310 may broadcast an N+1 address setting command and may then terminate the address setting procedure in response to an address setting completion for the N+1 address setting command not being confirmed during an expected response time.

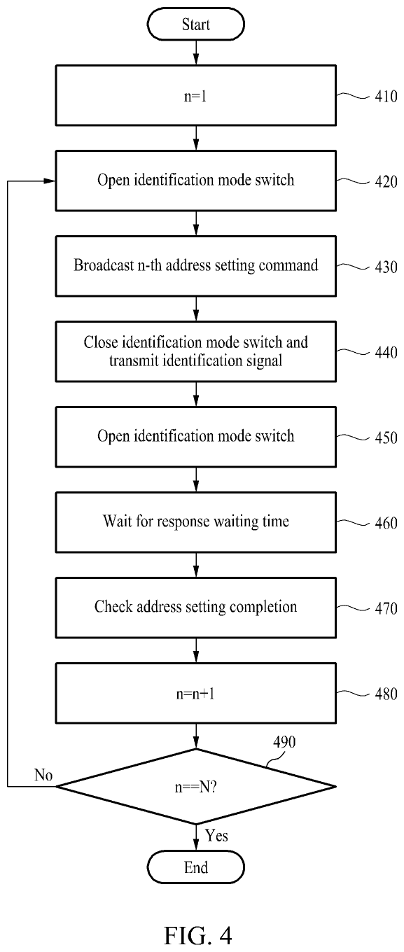

FIG. 4 illustrates an example method of setting an address of a master BMS according to one or more embodiments. Referring to FIG. 4, in a non-limiting example, in operation 410, the master BMS may initialize n to “1” (e.g., n=1). In an example, n may be a natural number from 1 to N. In an example, N may correspond to the number of slave BMSs.

In operation 420, the master BMS may open an identification mode switch. An identification mode switch of each slave BMS may also be in an open state. In operation 430, the master BMS may broadcast an n-th address setting command. In operation 440, the master BMS may close the identification mode switch and may transmit an identification signal. The slave BMSs may also close the identification mode switches and may enter a target identification mode. When n=1, a first slave BMS may be identified by the identification signal. In operation 450, the master BMS may open the identification mode switch. In operation 460, the master BMS may wait for a response waiting time. The first slave BMS may perform an address setting process during the response waiting time and may notify the master BMS of address setting completion. In operation 470, the master BMS may check the address setting completion.

The master BMS may increase n by 1 in operation 480 and may confirm if n is equal to N in operation 490. If n is not equal to N, the master BMS may perform operation 420 repeatedly. If n is equal to N, the master BMS may terminate an address setting procedure.

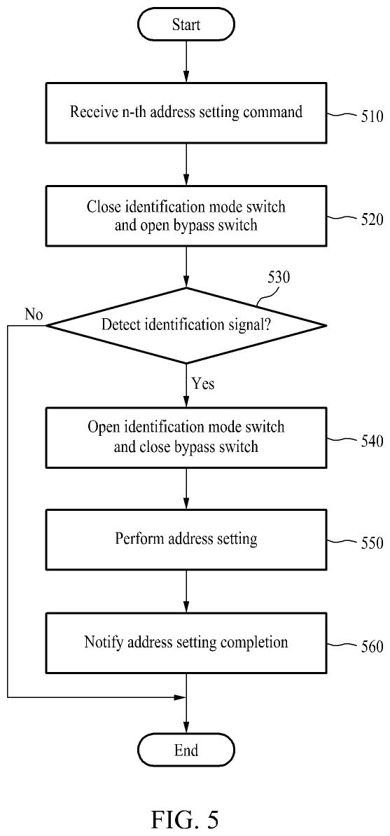

FIG. 5 illustrates an example method of an address setting process of slave BMSs according to one or more embodiments. Referring to FIG. 5, in a non-limiting example, in operation 510, an n-th slave BMS may receive an n-th address setting command. In operation 520, the n-th slave BMS may close an identification mode switch and may open a bypass switch. In operation 530, the n-th slave BMS may check whether an identification signal has been detected. When the identification signal has been detected, in operation 540, the n-th slave BMS may open the identification mode switch and close the bypass switch. In operation 550, the n-th slave BMS may perform an address setting process. In operation 560, the n-th slave BMS may notify a master BMS of address setting completion. The order of at least part of operations 540-560 may be adjusted according to examples.

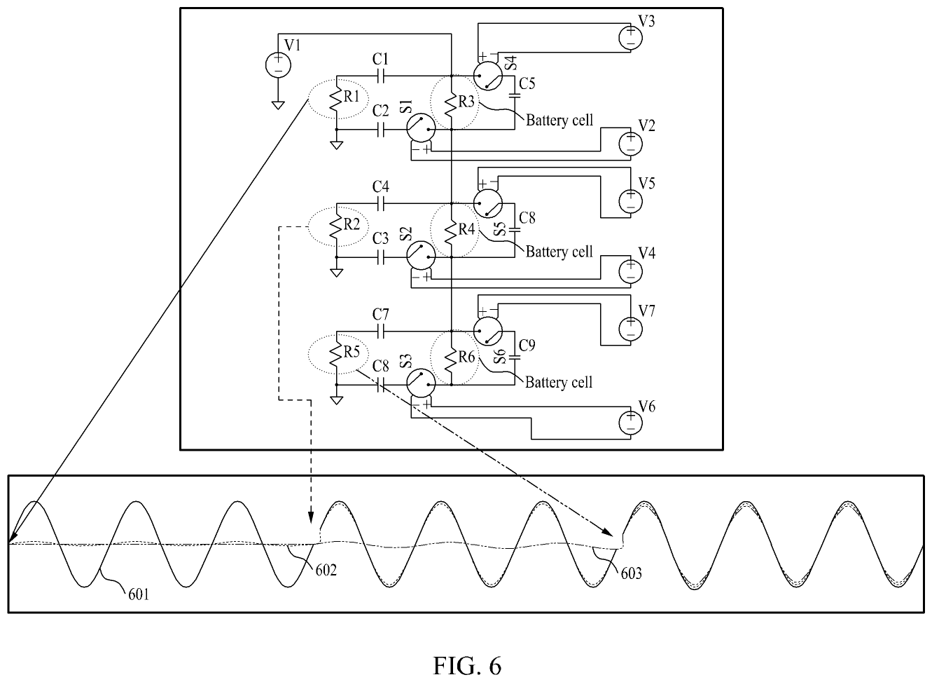

FIG. 6 illustrates an example method of changing a transferring path of an identification signal due to a switching operation according to one or more embodiments. Referring to FIG. 6, in a non-limiting example, a power supply V1 may correspond to an identification signal generator of a master BMS (e.g., master BMS 310), resistors R1, R2, and R3 may respectively correspond to identification signal detectors of slave BMSs (e.g., slave BMSs 320, 330, and 340), switches S1, S2, and S3 may respectively correspond to identification mode switches of the slave BMSs, and switches S4, S5, and S6 may respectively correspond to bypass switches of the slave BMSs.

In an example, an identification signal detector for detecting an identification signal may be changed by controlling the switches S1, S2, S3, S4, S5, and S6. In an example, the following recitations of PULSE( ) may correspond to a command of an LTspice model. In an example, PULSE (0 5 30000000 0 0 0 10000) for the power supply V1, PULSE (0 5 0 1n 1n 100n) for a power supply V2, PULSE (0 5 100n 1n 1n 200n) for a power supply V3, PULSE (0 5 0 1n 1n 200n) for a power supply V4, PULSE (0 5 200n 1n 1n 300n) for a power supply V5, PULSE (0 5 0 1n 1n 300n) for a power supply V6, and PULSE (0 5 300n 1n 1n 0n) for a power supply V7 may be used.

A first graph 601 may illustrate an example state in which the identification signal is detected by the identification signal detector of the first slave BMS, a second graph 602 may illustrate an example state in which the identification signal is detected by the identification signal detector of the second slave BMS, and a third graph 603 may illustrate an example state in which the identification signal is detected by the identification signal detector of the third slave BMS. As such, the identification signal may be transferred sequentially to the slave BMSs through the controlling of the identification mode switches and the bypass switches.

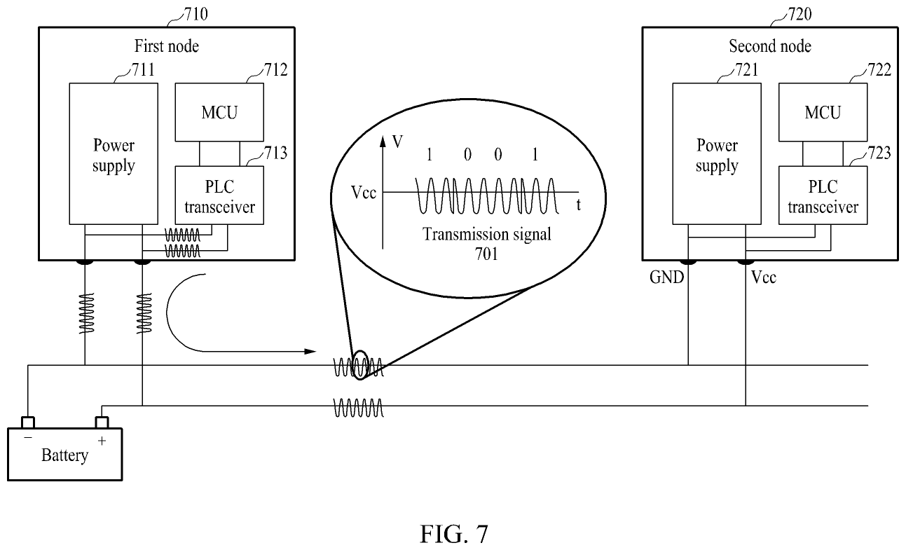

FIG. 7 illustrates an example method of transmitting an identification signal according to one or more embodiments.

Referring to FIG. 7, in a non-limiting example, a first node 710 may include a power supply 711, an MCU 712, and a PLC transceiver 713 and a second node 720 may include a power supply 721, an MCU 722, and a PLC transceiver 723. Power may be transferred through power lines between a battery and the power supplies 711 and 721. The MCUs 712 and 722 may communicate with one another using the power lines and the PLC transceivers 713 and 723. For example, the MCU 712 may transmit a transmission signal 701 to the MCU 722 through the power lines. Although FIG. 7 illustrates that the transmission signal 701 is a phase shift keying (PSK)-based transmission signal, in additional examples, various modulation techniques other than PSK may be applied to the transmission signal 701. The transmission signal 701 may also be an unmodulated signal. In additional examples, the PLC technology of the nodes 710 and 720 may be used by a master BMS and slave BMSs.

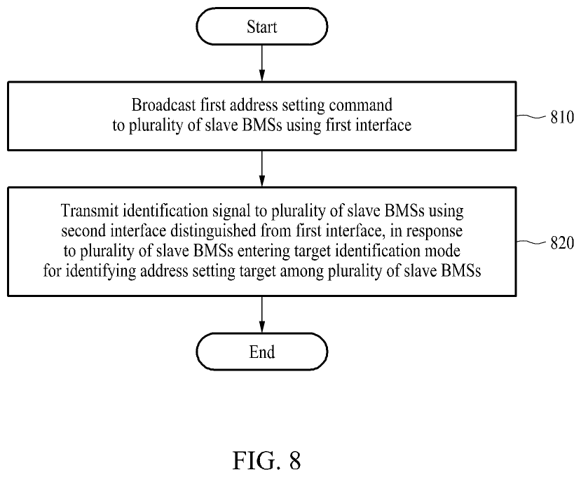

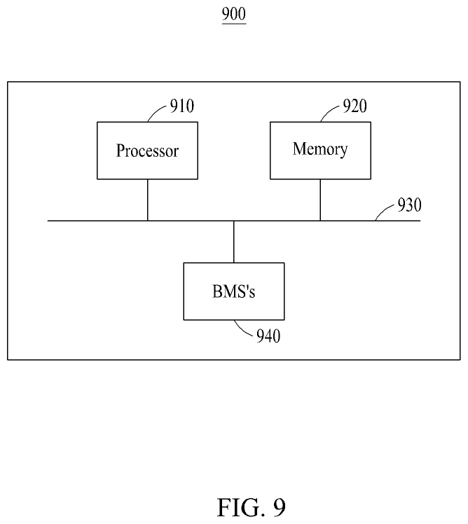

FIG. 8 illustrates an example battery management method of a master BMS according to one or more embodiments. Referring to FIG. 8, in a non-limiting example, in operation 810, the master BMS may broadcast a first address setting command to a plurality of slave BMSs using a first interface. In operation 820, when the plurality of slave BMSs enter a target identification mode for identifying an address setting target among the plurality of slave BMSs, the master BMS may transmit an identification signal to the plurality of slave BMSs using a second interface that is distinguished from the first interface. When the first slave BMS is identified among the plurality of slave BMSs by the identification signal in the target identification mode, an address setting according to the first address setting command may be performed by the first slave BMS.

In an example, as the plurality of slave BMSs enters the target identification mode, identification paths connecting an identification signal generator of the master BMS to the respective identification signal detectors of the plurality of slave BMSs may be activated.

The master BMS and the plurality of slave BMSs may include identification mode switches, respectively, and the identification paths may be activated as the respective identification mode switches of the master BMS and the plurality of slave BMSs are in a closed state in the target identification mode.

The first slave BMS may perform the address setting according to the first address setting command and then may cause a bypass switch of the first slave BMS to be in a closed state, and as the bypass switch of the first slave BMS is in the closed state, a partial path of the first slave BMS among the identification paths may be deactivated.

The first interface may connect the master BMS to the plurality of slave BMSs in parallel, and the second interface may connect the master BMS to the plurality of slave BMSs in series.

The second interface may correspond to a power line providing power from the respective battery modules of the plurality of slave BMSs, and the identification signal may use a high frequency that is distinguished from the frequency of the power from the respective battery modules of the plurality of slave BMSs.

In additional examples, the descriptions of FIGS. 1 to 7 may be applied to the battery management method of the master BMS of FIG. 8.

FIG. 9 illustrates an example electronic apparatus (or system) with battery management according to one or more embodiments.

Referring to FIG. 9, in a non-limiting example, an electronic apparatus 900 may include a processor 910 and a memory 920, bus 930, and one or more battery management systems (BMSs) 940. The processor 910, memory 920, and BMSs 940 may be connected via a bus 930. In an example, the BMSs 940 may be provided in the electronic vehicle, or within the battery pack and/or battery modules (e.g., battery pack 110 and battery modules 120 of FIG. 1) and communicate with the processor. The sensory interfaces may be temperature sensors and other sensors that monitor a battery status and control an operation of one or more batteries and other BMSs (e.g., master BMS and slave BMSs) as described in greater detail above with respect to FIGS. 1-8.

The processor 910 may be configured to execute computer-readable instructions, which when executed by the processor 910, to configure the processor 910 to perform one or more or all operations and/or methods involving the management of one or more batteries and/or battery modules, or perform any one or any combination of the operations and/or methods described herein. The processor 910 may include any one or a combination of two or more of, for example, a central processing unit (CPU), a processor core, a multi-core processor, and a multiprocessor. The processor 910 may also execute other computer-readable instructions, programs, or applications to control other functionalities of the electronic devices, the electronic systems, and the MCU (e.g., MCU 312 of FIG. 3).

The memory 920 may be configured to store, or store, any of the computer-readable instructions described herein. The memory 920 may be a volatile or nonvolatile memory.

The memory 920 may include, for example, random-access memory (RAM), dynamic random-access memory (DRAM), static random-access memory (SRAM), or other types of non-volatile memory known in the art.

The processors, memories, electronic apparatuses, electronic systems, battery management systems, battery packs, battery modules, electronic vehicles, switches, master BMS 210, slave BMSs 220, 230, 240, first interface 250, second interface 260, transceiver 311, MCU 312, identification signal generator 313, identification mode capacitor 314, identification mode ground capacitor 315, identification mode switch 316, and master ground 317, identification mode switches 316, 326, 336, and 346, and transceivers 311, 321, 331, and 341 described herein and disclosed herein described with respect to FIGS. 1-9 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-9 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. An electronic apparatus, comprising:
a plurality of slave battery management systems (BMSs) configured to manage battery cells of battery modules, respectively; and
a master BMS configured to manage the plurality of slave BMSs,
wherein, in response to the master BMS broadcasting a first address setting command to the plurality of slave BMSs using a first interface, the plurality of slave BMSs is configured to enter a target identification mode for identifying an address setting target among the plurality of slave BMSs,
wherein in response to the master BMS transmitting an identification signal to the plurality of slave BMSs using a second interface that is distinguished from the first interface, a first slave BMS is identified among the plurality of slave BMSs, and
wherein the first slave BMS is configured to perform an address setting process according to the first address setting command.

2. The apparatus of claim 1, wherein the master BMS comprises an identification signal generator,
wherein the plurality of slave BMSs comprises identification signal detectors, respectively, and
wherein, as the plurality of slave BMSs enters the target identification mode, identification paths connecting the identification signal generator to the respective identification signal detectors of the plurality of slave BMSs are activated.

3. The apparatus of claim 2, wherein the master BMS and the plurality of slave BMSs comprise identification mode switches, respectively, and
wherein the identification paths are activated as respective identification mode switches of the master BMS and the plurality of slave BMSs are in a closed state in the target identification mode.

4. The apparatus of claim 3, wherein the respective identification mode switches of the master BMS and the plurality of slave BMSs are in the closed state and then back in an open state in response to a reference time elapsing.

5. The apparatus of claim 2, wherein the first slave BMS is configured to perform the address setting process according to the first address setting command and then to cause a bypass switch of the first slave BMS to be in a closed state, and
wherein, as the bypass switch of the first slave BMS is in the closed state, a partial path of the first slave BMS among the identification paths is deactivated.

6. The apparatus of claim 5, wherein, in response to the master BMS broadcasting a second address setting command to the plurality of slave BMSs using the first interface, the plurality of slave BMSs is configured to enter the target identification mode,
wherein, in response to the master BMS transmitting the identification signal to the plurality of slave BMSs using the second interface, a second slave BMS is identified among the plurality of slave BMSs due to the deactivation of the partial path of the first slave BMS, and
wherein the second slave BMS is configured to perform the address setting process according to the second address setting command.

7. The apparatus of claim 6, wherein the first slave BMS is configured to notify the master BMS of address setting completion, after completing the address setting process according to the first address setting command.

8. The apparatus of claim 1, wherein the first interface is configured to connect the master BMS to the plurality of slave BMSs in parallel, and
wherein the second interface is configured to connect the master BMS to the plurality of slave BMSs in series.

9. The apparatus of claim 1, wherein the first interface corresponds to a data bus.

10. The apparatus of claim 1, wherein the second interface corresponds to a power line providing power from the respective battery modules of the plurality of slave BMSs.

11. The apparatus of claim 10, wherein the second interface is used for power line communication, and
wherein the identification signal uses a high frequency that is distinguished from a frequency of the power from the respective battery modules of the plurality of slave BMSs.

12. The apparatus of claim 1, wherein a number of slave BMSs is N,
wherein the plurality of slave BMSs is configured to notify the master BMS of address setting completion, after each completing of the address setting process, and
wherein the master BMS is configured to broadcast an N+1 address setting command, and
wherein the master BMS is configured to terminate the broadcasting of the N+1 address command in response to an address setting completion for the N+1 address setting command not being confirmed.

13. A processor-implemented, the method comprising:
broadcasting a first address setting command to a plurality of slave BMSs using a first interface; and
transmitting an identification signal to the plurality of slave BMSs using a second interface that is distinguished from the first interface, in response to the plurality of slave BMSs entering a target identification mode for identifying an address setting target among the plurality of slave BMSs,
wherein, in response to a first slave BMS being identified among the plurality of slave BMSs by the identification signal in the target identification mode, an address setting process according to the first address setting command is performed by the first slave BMS.

14. The method of claim 13, wherein, as the plurality of slave BMSs enters the target identification mode, identification paths connecting the identification signal generator to the respective identification signal detectors of the plurality of slave BMSs are activated.

15. The method of claim 14, wherein the master BMS and the plurality of slave BMSs comprise identification mode switches, respectively, and
wherein the identification paths are activated as respective identification mode switches of the master BMS and the plurality of slave BMSs are in a closed state in the target identification mode.

16. The method of claim 14, wherein the first slave BMS is configured to perform the address setting process according to the first address setting command and then to cause a bypass switch of the first slave BMS to be in a closed state, and
wherein, as the bypass switch of the first slave BMS is in the closed state, a partial path of the first slave BMS among the identification paths is deactivated.

17. The method of claim 13, wherein the first interface is configured to connect the master BMS to the plurality of slave BMSs in parallel, and
wherein the second interface is configured to connect the master BMS to the plurality of slave BMSs in series.

18. The method of claim 13, wherein the second interface corresponds to a power line providing power from the respective battery modules of the plurality of slave BMSs, and
wherein the identification signal uses a high frequency that is distinguished from a frequency of the power from the respective battery modules of the plurality of slave BMSs.

19. An electric vehicle, comprising:
a battery pack comprising a plurality of slave battery management systems (BMSs) configured to manage battery cells of battery modules, respectively, and a master BMS configured to manage the plurality of slave BMSs; and
an electric motor configured to provide power using the battery pack,
wherein, in response to the master BMS broadcasting a first address setting command to the plurality of slave BMSs using a first interface, the plurality of slave BMSs is configured to enter a target identification mode for identifying an address setting target among the plurality of slave BMSs,
wherein, in response to the master BMS transmitting an identification signal to the plurality of slave BMSs using a second interface that is distinguished from the first interface, a first slave BMS is identified among the plurality of slave BMSs, and
wherein the first slave BMS is configured to perform an address setting process according to the first address setting command.
